(19) United States
(12) Patent Application Publication
(10) Pub. No.: US 2024/0026859 A1
(43) Pub. Date: Jan. 25, 2024

(54) METHOD FOR MODIFYING A SOUND EMISSION OF A WIND POWER INSTALLATION

(71) Applicant: Wobben Properties GmbH, Aurich (DE)

(72) Inventor: Henning Küwen, Oldenburg (DE)

(21) Appl. No.: 18/354,470

(22) Filed: Jul. 18, 2023

(30) Foreign Application Priority Data
Jul. 20, 2022 (EP) 22186125.5

(51) Int. Cl. F03D 7/02

(52) U.S. Cl. CPC F03D 7/0296; F05B 2270/333; F05B 2220/706; F05B 2260/962; F05B 2260/20

(57) ABSTRACT

A method for modifying a sound emission of a wind power installation, wherein the wind power installation comprises a nacelle and a generator with a rotor which is adjustable in terms of its rotational speed, and the rotor has at least one rotor blade, the generator produces sound with at least one characteristic generator sound frequency which depends on the rotor rotational speed, the wind power installation has at least one fan for cooling the nacelle and/or generator, the at least one fan is adjustable in terms of a fan rotational speed, wherein the at least one fan produces sound with a characteristic fan sound frequency which depends on the fan rotational speed, and the fan rotational speed of the at least one fan is set in such a way on the basis of the rotor rotational speed that the fan sound frequency deviates from the at least one generator sound frequency. Tonal sounds in wind power installations, or the perception thereof, are intended to be reduced in particular.

### BACKGROUND

### Technical Field

The present disclosure relates to a method for modifying a sound emission of a wind power installation. The present disclosure also relates to a wind power installation in which such a method is implemented.

### Description of the Related Art

Wind power installations are known and usually have a generator for producing electrical energy from the rotation of a rotor which is driven by wind. However, the generator of the wind power installation also produces sound in the process. This sound propagates and can be perceived as bothersome noise at an emission location. In addition to the generator, there may be further sources of sound in conventional wind power installations.

To protect persons at the emission location, it is necessary to observe specifications in relation to the sound emission. One of these specifications is determined from a sound measurement pursuant to DIN 61400-11.

In addition to the volume, which is to say the amplitude of the sound, psychoacoustic effects are also considered in the process. What is considered particularly bothersome here is if a sound is distinctly audible over the background sound, in particular a broadband sound produced by the rotor blades. In the case of a tonal analysis, this can be identified, inter alia, by virtue of the local amplitude at a certain frequency being located significantly above a base spectrum. This effect is also referred to as tonal sound.

Tonal sounds consequently occur if individual tones emerge clearly or are audible within a sound spectrum. For example, this effect may occur if an arising frequency is equal or approximately equal to an eigenfrequency and resonances occur. It may also occur if a sound-producing component itself has a dominant frequency which is emitted as sound, and the latter is audible over other sources of sound.

Tonal sounds are also taken into account in the specifications for wind power installations. The stronger the effect, which is to say the stronger the tonal sounds, the quieter this overall sound produced by the wind power installation must be. The sound amplitude must be lowered in that case.

Thus, the rotational speed of the rotor may have to be lowered under certain circumstances in order to be able to observe the specifications, and hence less electrical power can be fed into the grid. It may even be the case that the wind power installation must not be operated in the affected mode of operation, and has to be switched off in the worst-case scenario.

### BRIEF SUMMARY

Provided are methods and systems to reduce tonal sounds in wind power installations, or the perception thereof.

Provided is a method relating to a modification of a sound emission of a wind power installation. The underlying wind power installation comprises a nacelle and a generator with a rotor which is adjustable in terms of its rotational speed. The rotor has at least one rotor blade. The generator produces sound with at least one characteristic generator sound frequency which depends on the rotor rotational speed. The wind power installation has at least one fan for cooling the nacelle and/or generator, and the at least one fan is adjustable in terms of a fan rotational speed. In this case, the at least one fan produces sound with a characteristic fan sound frequency which depends on the fan rotational speed. The fan rotational speed of the at least one fan is set in such a way on the basis of the rotor rotational speed that the fan sound frequency deviates from the at least one generator sound frequency.

The characteristic generator sound frequency is the frequency corresponding to a dominant tone of the generator sound. In this case, the characteristic generator sound frequency or the dominant tone is caused by the structure of the generator.

As a rule, generator sound with a characteristic generator sound frequency is significantly higher in terms of its amplitude than the remaining sound with a spectrum in the range of the characteristic generator sound frequency. Figuratively, the generator sound at the generator sound frequency emerges from the sound with the remaining adjacent spectrum. The greater the difference between the amplitude of the generator sound at the characteristic generator sound frequency and the amplitude of the sound of the surrounding base spectrum, the more likely generator sound at the generator sound frequency is perceived as an unpleasant individual tone.

It has now been recognized that there might be a disadvantageous superposition of the fan sound of the at least one fan on the generator sound, as a result of which the amplitude at the characteristic generator sound frequency emerges even more significantly from the ambient base spectrum. Thus, a disadvantageous superposition is understood to mean that the resultant sound of the superposition of the generator sound and fan sound has a greater amplitude than the individual sounds and/or that at least the peak of the overall sound at the generator sound frequency rises more pronouncedly from the base spectrum than the peak of the generator sound on its own.

What was recognized in the process is that the fan sound likewise has a characteristic fan sound frequency, which can be assigned to a dominant tone of the fan sound. The characteristic fan sound frequency depends on the fan rotational speed and a number of fan rotor blades.

Consequently, the fan rotational speed is set in such a way that the resultant characteristic fan sound frequency differs from the generator sound frequency, with the result that there is not a disadvantageous superposition of fan sound and generator sound.

Additionally, it was recognized that the perception of sound can be improved by virtue of setting the fan rotational speed so that the fan sound frequency is driven to approach the generator sound frequency in order to mask the generator sound. Thus, it is proposed to set the fan rotational speed so that the characteristic fan sound frequency is located in the region of the generator sound frequency, which is to say in the vicinity thereof.

On the one hand, there is thus the avoidance of the generator sound frequency, whereby disadvantageous superpositions are avoided. On the other hand, the generator sound is masked by driving the fan sound frequency to approach the generator sound frequency. In other words, the generator sound is broadened in terms of its frequency, with the result that it is no longer perceived as a single tone. The advantage of this is that tonal sounds are avoided as a result.

How far the fan sound frequency needs to deviate from the generator sound frequency in order to obtain an optimum between disadvantageous superposition and desired masking can be determined experimentally and/or by simulations.

It was also recognized that the generator might produce generator sound with a plurality of dominant tones, which is to say dominant frequencies. In that case, the generator sound has a peak at a plurality of characteristic generator sound frequencies. It is proposed to set the fan rotational speed of the at least one fan in such a way that the resultant fan sound frequency deviates from all generator sound frequencies.

It was further recognized that there may also be a disadvantageous superposition of the fan sound frequencies of a plurality of fans, especially if fans of identical construction are operated at an identical rotational speed. It is therefore also proposed to set the fan rotational speeds of the individual fans in such a way that the resultant fan sound frequencies deviate from one another. This also avoids a disadvantageous superposition. What should be taken into account in turn in the process is that the fan rotational speeds and hence the fan sound frequencies are set so that the generator sound and/or the fan sound of the remaining fans is masked.

According to a further aspect, at least one critical fan rotational speed is determined on the basis of the rotor rotational speed as a rotational speed to be avoided by the respective fan. The fan rotational speed of each fan is specified in such a way that the at least one critical fan rotational speed is avoided. In this case, the at least one critical fan rotational speed is the same for fans of identical construction. As an alternative or in addition, the at least one critical fan rotational speed corresponds to a fan rotational speed at which the associated fan sound frequency corresponds to the generator sound frequency.

A simple implementation of the method is realized by determining the at least one critical fan rotational speed. To this end, a function or table for example may be stored, on the basis of which it is possible to determine the critical fan rotational speed depending on the rotor rotational speed. It is also possible to base this on a calculation equation, on the basis of which the at least one critical fan rotational speed can be calculated depending on the rotor rotational speed. It is thus possible to determine the at least one critical fan rotational speed for a given rotor rotational speed, and the rotational speed of the respective fan can be set so that the critical fan rotational speed is avoided.

In so doing, the characteristic fan sound frequency setting in for a given fan rotational speed is known or can be calculated. It is likewise known, or possible to calculate, the characteristic generator sound frequency which sets in for a given rotor rotational speed. Therefore, it is also possible to determine the fan rotational speed that should be avoided. Specifically, precisely the fan rotational speed which leads to a characteristic fan sound frequency that corresponds to the generator sound frequency.

In particular, it was also recognized that the characteristic fan sound frequency is specified by the fan for structural reasons. Consequently, the at least one critical fan rotational speed is the same for fans of identical construction. What was found in this context is that the calculation or determination of the at least one critical fan rotational speed must only be performed once for fans of identical construction.

According to a further aspect, a harmonic of a frequency variable of the generator, on which the sound depends, is used as the generator sound frequency. In particular, a harmonic of a pole passing frequency is used. The pole passing frequency specifies how often a rotor pole passes a reference position. In particular, the 12th harmonic of the frequency variable is used.

A fundamental frequency or harmonic of the sound produced by the fan is used as the fan sound frequency. In particular, the fan sound frequency f_{L} is a blade passing frequency. The fan sound frequency f_{L} is determined in particular depending on the fan rotational speed n_{L} and a number of fan rotor blades A_{L}. In particular, the fan sound frequency is determined according to the following formula:

$${f}_{L} [ Hz ] = {n}_{L} \frac{[ rpm ]}{60} \cdot {A}_{L}$$

The frequency variable of the generator is consequently a frequency which physically arises at the generator and which influences the sound.

For example, such a frequency variable can be the frequency at which the generator mechanically rotates. The frequency variable is preferably the pole passing frequency.

The pole passing frequency denotes the frequency with which a rotor pole passes a freely selectable reference point. Thus, depending on the number of rotor poles of the rotor, it corresponds to a multiple of the current rotational frequency of the rotor.

Sound at the generator sound frequency is produced by the repeated passage of the reference point or any other point.

It was also recognized that half the pole passing frequency may be such a frequency variable that influences the sound. In this context, it was recognized that the sound depends on an interplay between rotor and stator, and hence may depend on the magnetization of each rotor pole. Therefore, it is also proposed in particular to use a harmonic of half the pole passing frequency as generator sound frequency. How often a reference point is passed by every second pole is relevant in the case of the half pole passing frequency. This is based on the fact that two adjacent poles have different magnetization. The magnetization leads to a strong interaction between rotor and stator; naturally, this is essential to the operational principle of the generator and hence the current production, but may also have influence on the noise development or sound generation. On account of this changing magnetization or magnetization direction from one pole to the next, it may be half the pole passing frequency that is relevant instead of the pole passing frequency. As a simplification, the number of pole pairs instead of the number of poles can also be used here for the calculation.

The frequency variable, and hence also the generator sound frequency, is therefore caused or determined by the structure of the generator. Moreover, the frequency variable and the generator sound frequency are dependent on the rotor rotational speed.

For structural reasons, a generator has a plurality of slots in the stator, which is to say stator slots, with a corresponding stator winding. Consequently, for simplification, the stator slots can be referred to simply as slots. In the case of a 6-phase generator, there are for example 6 stator slots per rotor pole. Consequently, the generator has 12 stator slots per pole pair, which consist of two rotor poles each. In this case, an order k of the harmonics corresponds to the number of stator slots per pole pair. In this example, the order is consequently k=12. Then, the characteristic generator sound frequency thus is the 12th harmonic for the half pole passing frequency. Consequently, the number of slots of the generator is particularly decisive for the characteristic generator sound frequency. Inter alia, the 6th and 18th harmonic were recognized as further important harmonics, especially in relation to the half pole passing frequency.

From the number of pole pairs P_{G} of the generator and the rotor rotational speed n_{R}, the characteristic generator sound frequency is consequently determined as

$${f}_{G} [ Hz ] = {n}_{R} \frac{[ rpm ]}{60} \cdot {P}_{G} \cdot k .$$

The fan also produces a sound for structural reasons, and so the fan sound frequency depends on the structure of the fan. Preferably, the fan sound frequency is the blade passing frequency, which specifies how frequently a fan rotor blade of the fan passes a chosen reference point each second. The passage of the fan rotor blades produces a vibrating noise at the blade passing frequency. However, it is also possible for harmonics, which is to say integer multiples of the blade passing frequency, to dominate the spectrum and be taken into account as fan sound frequency.

According to a further aspect, the fan rotational speed of the at least one fan is specified in such a way that the associated fan sound frequency deviates from the generator sound frequency by no more than a specifiable masking deviation, in order to mask the generator sound frequency.

Consequently, the resultant fan sound frequency differs from the generator sound frequency but still is in a region of the generator sound frequency. In this case, the masking deviation is specified so that generator sound and fan sound cannot be perceived as different tones. Thus, what is achieved is that a frequency bandwidth of the generator sound is broadened at the characteristic generator sound frequency. In that case, the resultant sound no longer has a sharp peak at the generator sound frequency and is perceived as less unpleasant.

In this case, the generator sound frequency is masked on the basis of an absolute noise level of the resultant overall sound. By way of example, it may be disadvantageous to carry out masking in the lower rotational speed range of the rotor. The generator sound frequency is not masked if the cooling effect especially is at the forefront.

According to a further aspect, the critical fan rotational speed n_{L,i} is determined for each fan i on the basis of the rotor rotational speed n_{R}, a number of pole pairs P_{G} of the generator, a number or the number of fan rotor blades A_{L,i} of the fan i and an order k of the sound produced by the generator. The order k is a characteristic order of the generator and/or can be considered as the order of the harmonic which is used as generator sound frequency. In particular or as an alternative, it may have a value of 6, 12 or 18. Consequently, the 6th, 12th or 18th harmonic can be the generator sound frequency for this. Preferably, the order k denotes a number of slots, which is to say stator slots, per pole pair. Then, the order k may correspond to twice the value of the number of phases of the generator, which is to say precisely the number of slots per pole pair. Then, the order is 12 (k=12) in the case of a 6-phase generator.

In particular, it was recognized that the generator sound frequency is determined by the number of pole pairs, which is to say of the rotor, together with the number of phases of the generator, specifically of the stator, together with the rotor rotational speed. Depending on the rotor rotational speed, this makes it possible to easily determine a critical fan rotational speed, which is to say a fan rotational speed to be avoided. Consequently, an appropriately adapted fan rotational speed can be determined and set in a simple manner.

Then, the critical fan rotational speed is determined as

$${n}_{L , i} = \frac{{n}_{R} \cdot k \cdot {P}_{G}}{{A}_{L , i}}$$

Thus, the critical fan rotation speed can be determined by equating the fan sound frequency f_{L} with the generation sound frequency f_{G}, and rearranging for the fan rotational speed.

The fan rotational speed to be set for each fan should therefore deviate from this critical fan rotational speed, in particular be located outside a specifiable range around the critical fan rotational speed. This is achieved by virtue of the setting-in characteristic fan sound frequency differing from the characteristic generator sound frequency.

According to a further aspect, the wind power installation comprises a plurality of fans for cooling the nacelle and/or generator. The fans are each adjustable in terms of their fan rotational speed and each produce sound with a characteristic fan sound frequency which depends on their fan rotational speed. Each of the fan rotational speeds is set, respectively dependent on the rotor rotational speed, in such a way that its fan sound frequency deviates from the generator sound frequency. Preferably, the fan rotational speeds are set in such a way that their fan sound frequencies also differ from one another.

In this context, it was recognized that the fans may also produce sound at a characteristic fan sound frequency which may disadvantageously be superposed on one another. For example, this would be the case if the same fan rotational speed were specified for each fan, in particular for each fan of identical construction, and consequently all fans would have a peak in the sound spectrum at the same fan sound frequency. As a result of the superposition, the amplitude of the resultant sound would emerge more clearly from the base spectrum at the fan sound frequency than would be the case if each fan were to be considered on an individual basis. Precisely this should be avoided since a very pronounced peak in the base spectrum is perceived as unpleasant. Therefore, fans of identical construction are set with different fan rotational speeds.

This is likewise implemented in a manner dependent on the rotor rotational speed since the generator sound frequency should also still be avoided by the fans.

Further, it was recognized that the effect of masking the generator sound can be amplified by way of differently set fan rotational speeds, and hence by different resultant fan sound frequencies in particular, and that the fans can also mask one another. Consequently, all fans are used to mask the generator sound frequency.

Each fan sound and the generator sound thus have a peak with a certain frequency bandwidth, at the respective fan sound frequency and generator sound frequency respectively. What is intended to be achieved by setting the fan rotational speed is that these resultant peaks slightly overlap at the edge of the frequency bandwidth and there is a superposition in this way. What is achieved by a suitable choice of the fan sound frequencies is that a plateau sets in in the amplitude of the sound, the said plateau extending over a broader frequency range than the individual peaks of the generator sound or fan sound. This effectively broadens the frequency of the generator sound.

As a result of all fan sound frequencies and the generator sound frequencies differing from one another, it is possible at the same time to keep the amplitude of the plateau low.

According to a further aspect, at least one frequency spacing is specified as the frequency difference respectively between two fan sound frequencies of two fans. The fan rotational speeds of the fans are set in such a way on the basis of the frequency spacing that the fan sound frequencies of at least two fans are at the frequency spacing from one another.

Thus, the frequency spacing is specified in order to avoid a disadvantageous superposition of the sound from two fans. Thus, the respective fan rotational speeds are set so that the fans each produce a sound at a different fan sound frequency.

The spectrum of the sound from the respective fan consequently has a peak with a certain frequency bandwidth at the respective fan sound frequency. In this case, the at least one frequency spacing is chosen to be so small that there is an overlap of the frequency range of the one fan with the frequency range of the other fan. However, at the same time, the frequency spacing is chosen to be so large that the resultant amplitude of the sound remains small. Firstly, this avoids a disadvantageous superposition with resultant sound levels that are too high and, secondly, this achieves masking, with the result that the sound signals of the fans are not perceived as different tones.

According to a further aspect, the frequency spacing is variably adjustable as the frequency difference respectively between two fan sound frequencies of two fans. As an alternative or in addition, the frequency spacing among the fans is different from one another. Preferably, the frequency spacing is chosen on the basis of at least one weather parameter, from the list comprising an outside temperature, a humidity, an atmospheric pressure, a rate of precipitation, a droplet size, a rate of snowfall and a wind speed.

It was recognized that the generator sound can be masked particularly effectively if the fan sound frequencies do not all have the same spacing from one another. For example, the frequency spacing between the first and the second fan then is one hertz for example, but for example two hertz between the second and third fan, etc.

The resultant frequency spectrum may have a plateau as a result of the unequal spacing of the fan sound frequencies. This avoids local frequency peaks, which may occur if the spacings between two respective fan sound frequencies are always the same. Otherwise, a plurality of peaks may arise in the spectrum, the said peaks being perceivable as individual tones and possibly being perceived as annoying.

This is avoided as a result of the unequal spacings of the fan sound frequencies. Some of these spacings can also be chosen to be small as a result of the unequal spacings of the fan sound frequencies, with the result that it is possible overall to obtain a narrower resultant spectrum, which is to say a narrower plateau, whereby rotational speeds that are too low and hence a cooling performance considered too poor are avoided. The variable frequency spacing constantly makes it possible to achieve a high mean cooling power with, at the same time, a low amplitude of the resultant sound. This flexibility of optimization by way of varying individual frequencies spacings is not provided in the case of a fixed frequency spacing between all fans.

By way of simulations and/or experiments, it is possible to find suitable fan rotational speeds which lead to fan sound frequencies which have a broad frequency range with a plateau of low sound amplitude in the resultant sound.

In particular, it was also recognized that weather parameters also influence the sound frequency of the fans, the perception thereof and/or the propagation thereof.

In particular, the weather parameters as a result also influence the frequency spacing to be chosen between two fans and, in particular, the fan rotational speed of the respective fans to be set. What is decisive in this case is what the spectrum of the sound looks like at the emission location, which is to say how the sound is perceived at the emission location. Therefore, the fan sound frequencies must be specified so that a broadening of the fan tone at the emission location is achieved.

It was recognized in this context that a sound propagation of the resultant sound is subjected to stronger dampening when the outside temperature falls. Therefore, the amplitude of the sound at the emission location is smaller at lower temperatures, with the result that a sound production with a higher amplitude is also admissible. The fan rotational speeds can then be set for a better cooling effect.

The humidity also has an influence on the sound propagation. The more humid the air, the better the sound can propagate. As the air gets more humid, the frequency spacing between the fans is therefore chosen to be greater in order to obtain a sound plateau that is as low as possible. As the air becomes drier, a high sound level becomes less critical and the fans can be set for optimal cooling.

Likewise, a greater perception of sound should be assumed in the case of a higher atmospheric pressure. The greater the air pressure, the more important a sound-optimized setting of the frequency spacings becomes.

The sound emission at the emission location is already elevated in the case of a high rate of precipitation. A high sound emission by the wind power installation is therefore less critical. The frequency spacing can also be chosen to be smaller in this case, and the fans can be used for optimal cooling.

A droplet size, which is to say when it rains, also has an effect on the sound emission. The larger the droplets, the louder the ambient noise due to the precipitation. Consequently, the frequency spacings can also be chosen more freely in this case.

When there is snowfall, the sound can moreover be damped by the masses of snow. Consequently, the frequency spacing can be chosen to be smaller as the snowfall increases.

The wind speed and/or wind direction likewise affect the sound propagation. Depending on the wind direction, the sound is driven towards or carried away from the emission location. Additionally, the sound is still perceived at greater distances in the case of higher wind speeds. Consequently, a sound-optimized setting of the frequency spacings should be chosen whenever the wind direction points toward the emission location and/or the wind speed is high.

According to a further aspect, the frequency spacing is variably adjustable as the frequency difference respectively between two fan sound frequencies of two fans. The frequency spacing between the fans decreases with increasing distance from the generator sound frequency.

This is advantageous in that this particularly effectively achieves a plateau in the volume of the resultant sound without a peak forming due to the fan with the greatest frequency spacing from the generator sound frequency.

According to a further aspect, the frequency spacing is specified as the frequency difference respectively between two fan sound frequencies of two fans, depending on the rotor rotational speed. The frequency spacing is specified to be ever smaller, the lower the rotor rotational speed is.

In this case, it was recognized that the amplitude of the generator sound also reduces with a lower rotor rotational speed. Consequently, the sound becomes quieter overall. This also has as a consequence that the sound overall is perceived to be less annoying. In that case, the frequency spacings can also be chosen to be smaller. The fans can then obtain a better cooling effect.

It was also recognized that, as a result of the lower sound level, a lower frequency bandwidth of the fan sound often sets in in the case of a lower rotor rotational speed, especially if the frequency edge is defined by a sound level. For this reason, too, the frequency spacings can be chosen to be smaller in the case of a lower rotor rotational speed.

According to a further aspect, the generator sound frequency has a tone bandwidth, in particular an ERB bandwidth. The tone bandwidth defines a characteristic frequency range around the generator sound frequency.

Depending on the tone bandwidth, a frequency range to be avoided, with an avoidance bandwidth, is determined. The avoidance bandwidth defines the frequency range to be avoided as the frequency range around the generator sound frequency. The avoidance bandwidth is smaller than the tone bandwidth, with the result that the frequency range to be avoided is located within the characteristic frequency range. The fan rotational speed of each fan is set so that the fan sound frequency is located outside of the frequency range to be avoided and/or within the characteristic frequency range.

What is taken into account here is that, depending on the tone frequency, a region on the basilar membrane which can be considered a bandpass filter is excited in the ear of a human. The bandpass bandwidth varies with the frequency. The sound to be masked should be located within the bandpass in order to obtain effective masking.

The tone bandwidth is now understood as the bandwidth which such a theoretical bandpass filter of the basilar membrane in the ear has at the generator sound frequency. The tone bandwidth therefore depends on the generator sound frequency.

In particular, the ERB bandwidth is used as the tone bandwidth, with ERB being an abbreviation for equivalent rectangular bandwidth. In psychoacoustics, the ERB bandwidth describes an approximation of the bandwidth of the filters of the human hearing. In this case, the filters are assumed as rectangular for simplification purposes.

It has now been recognized that, in order to mask the generator sound, a background noise must be located within the characteristic frequency range defined by the tone bandwidth.

It is for this reason that the fans are set so that the fan sound frequency is located within the characteristic frequency range. In the process, the narrow peak of the generator tone at the generator sound frequency is broadened and perceived as less unpleasant.

This should be achieved at least up to a maximum rotational speed of the fan and hence to a maximum fan sound frequency.

However, it was also recognized that the rotational speed of each fan must be set so that a disadvantageous superposition of the amplitude maxima of the fan sound and the generator sound is avoided. Thus, the resultant sound should not become louder but broader in terms of its spectrum. This is achieved by virtue of the frequency range to be avoided, within which the fan sound frequency should not be located.

According to a further aspect, the fan rotational speed is respectively specified as a fan rotational speed characteristic. The fan rotational speed characteristic describes a function of the fan rotational speed depending on the rotor rotational speed. In particular, the fan rotational speed characteristic is provided as a linear characteristic.

In the case of a current rotor rotational speed, the fan rotational speed is specified in accordance with the fan rotational speed characteristic. This ensures simple implementation since the fan rotational speed can be easily set on the basis of the characteristic, without the need for an explicit determination of the resultant fan sound frequency.

In this case, the fan rotational speed characteristic may be determined in advance. Simulations or experiments are suitable to this end. However, the fan rotational speed characteristic may also be calculated.

If the fan rotational speed characteristic is moreover set to be linear, then it is possible to realize a simple control. Moreover, it is advantageous that, independently of the rotor rotational speed, the resultant fan sound frequencies may have a constant frequency spacing from the generator sound frequency, depending on the choice or gradient of the fan rotational speed characteristic.

The fan rotational speed characteristic is linear, especially if the rotational speed of the fan n_{L} can be calculated by way of the rotor rotational speed n_{R} that has been multiplied by a factor m, wherein a constant offset c can be taken into account. For example, the fan rotational speed could then be calculated as

n_{L}=m·n_{R}+c.

According to a further aspect, a dedicated fan rotational speed characteristic is provided for each fan. The fan rotational speed characteristics of a plurality of fans respectively deviate from one another by a specifiable rotational speed deviation criterion.

In particular, provision is made for the fan rotational speed characteristics of a plurality of fans to be shifted from one another by a specifiable difference rotational speed and/or to deviate from one another by a rotational speed deviation factor ranging between 0.8 and 1.2.

Consequently, a different fan rotational speed characteristic is specified for each fan in order to arrive at the situation where each fan produces a fan sound with a different fan sound frequency.

What is decisive in this case is that the resultant fan sound frequencies are at least spaced so far apart that a superposition which increases the volume is avoided. The rotational speed deviation criterion consequently ensures that the fan rotational speeds of two fans are spaced at least so far apart that there is not a disadvantageous superposition of the resultant fan sound frequencies, thus leading to a higher amplitude.

The rotational speed deviation criterion can be achieved particularly easily by the specification of a difference rotational speed. The difference rotational speed can be determined in advance as the difference between two fan rotational speeds, which must be set so that, firstly, the fans optimally mask the generator sound and, secondly, there is not a disadvantageous superposition of the fan sound signals.

As an alternative or in addition, the rotational speed deviation criterion may also be specified as a rotational speed deviation factor. In that case, the fan rotational speed characteristic of a first fan corresponds to the fan rotational speed characteristic of a second fan, multiplied by the rotational speed deviation factor. The fan rotational speed characteristics are then inclined relative to one another.

The rotational speed deviation criterion can also be achieved particularly easily by specifying a power difference. In that case, the power of one fan is set 1% lower, for example, than that of another fan. Instead of 100% of its power, the fan is then set to 99% of its possible power.

As an alternative or in addition, provision is made for fan sound frequency characteristics, which are associated with the fan rotational speed characteristics and each describe a fan sound frequency depending on the rotor rotational speed, of a plurality of fans to respectively deviate from one another by a specifiable frequency deviation criterion.

In particular, provision is made for the fan sound frequency characteristics of a plurality of fans to be shifted from one another by a specifiable difference frequency and/or to deviate from one another by a frequency deviation factor, which may correspond to the rotational speed deviation factor, ranging between 0.8 and 1.2.

Instead of directly specifying the rotational speed, it is also possible to specify the fan sound frequency which should be set for a given rotor rotational speed. The fan rotational speed characteristic, which assigns a fan sound frequency of the fan to be set to each rotor rotational speed, is particularly suitable to this end.

In this case, too, each fan is assigned a different fan rotational speed characteristic in order to enable suitable masking and in order to avoid a disadvantageous superposition of the fan sound signals. In this case, the frequency deviation criterion ensures that there is not such a superposition of the fan sound frequencies of the fans that the amplitude of the resultant sound is increased. Moreover, consideration is given to the fact that the intention is to obtain masking of the generator sound. The consideration can be given directly by way of the respectively associated fan sound frequency characteristics.

The frequency deviation criterion can easily be implemented by virtue of the difference frequency being specified for the fan sound frequency characteristics. Consequently, each fan sound frequency deviates from the fan sound frequency of the closest fan by the difference frequency.

It was recognized that a preferred difference frequency is located between 2 Hz and 5 Hz, and particularly preferably is around 3.5 Hz.

As an alternative or in addition, provision is also made here for the frequency deviation factor to be specified, the latter specifying how far the fan sound frequency characteristics are shifted relative to one another.

It is also possible to specify both the fan rotational speed characteristics and the fan sound frequency characteristics for the fans. Then, the rotational speed of a fan is for example primarily set on the basis of the fan rotational speed characteristic and the fan sound frequency characteristics can be used to verification purposes. If it is recognized that the resultant fan rotational speed deviates from the associated fan sound frequency characteristic by a specifiable value, then it is possible to react accordingly, and the fan rotational speed can be corrected in accordance with the fan sound frequency characteristic.

According to a further aspect, the wind power installation comprises at least two fans for cooling the nacelle and/or generator. The fans can be sorted in a fan sequence. The fan rotational speeds or fan rotational speed characteristics of the fans are selected in accordance with the fan sequence. In addition, the fan sequence is modified in such a way after a specifiable exchange time or on the basis of another exchange criterion that the fan rotational speeds or fan rotational speed characteristics of the fans are selected anew in accordance with the modified fan sequence.

The idea is to keep the cooling power of each fan equally high where possible. If the fan rotational speed of a fan is reduced, then its cooling power also drops. Thus, if the fans are operated at different fan rotational speeds, their cooling power will also differ from one another. One fan then cools more than the other fan, and there is an unevenly distributed cooling effect and/or different wear of the fans.

It was recognized that it may therefore be advantageous to exchange the rotational speeds of the fans amongst themselves so that the cooling effect is distributed more uniformly. As a result, different fans are always alternately operated at the highest, lowest and any other rotational speed. An efficiency of the fans can also be improved by interchanging the fan rotational speeds.

To this end, the fans can be numbered and sorted on the basis of the fan sequence. The fan rotational speeds or fan rotational speed characteristics can be specifically assigned to the fans in alternating fashion. One option for simple implementation lies in selecting these in accordance with the fan sequence for the assignment of the fan rotational speed to be set. In particular, the assumption is made here that the fans are of identical construction, or at least have the same rotational speed ranges.

The fans are resorted after the exchange time has expired. This effectively assigns each fan a new fan rotational speed or fan rotational speed characteristics.

Alternatively, the exchange criterion is specified. In this case, the fan sequence can for example be modified if a desired cooling temperature is no longer achieved in the region of a fan. A further criterion might be given by the power of the fans.

According to a further aspect, the wind power installation has at least one further source of noise and the at least one further source of noise produces further sound at in each case a constant frequency. The fan rotational speed of the at least one fan is set in such a way that the fan sound frequency deviates from the constant frequency.

By way of example, a transformer of the wind power installation forms such a source of noise.

An advantage arising herefrom is that the fan sound and the sound from the further source of noise are not superposed such that that there is an increase in the amplitude of the overall sound. In other words, the sound from the source of noise is also masked at the same time, which is a positive effect.

A further advantage is that the sound from the further source of noise already contributes to the masking of the generator sound. It thus contributes to the broadening of the generator sound frequency. This can be exploited by virtue of the fan rotational speed being set while avoiding a constant frequency. As a result, the generator frequency can be broadened even further.

Provided is wind power installation comprising a nacelle and a generator with a rotor which is adjustable in terms of its rotational speed, wherein the rotor has at least one rotor blade. The generator produces sound with at least one characteristic generator sound frequency which depends on the rotor rotational speed.

The wind power installation has at least one fan for cooling the nacelle and/or generator. The at least one fan is adjustable in terms of a fan rotational speed, wherein the at least one fan produces sound with a characteristic fan sound frequency which depends on the fan rotational speed.

A sound emission can preferably be captured, in particular by way of a microphone. The capture can be dispensed with if the expectable sound emission is known or derivable from settings of the wind power installation, in particular from the generator rotational speed and/or a generator power. The wind power installation also has a control module.

The control module sets a fan rotational speed of the at least one fan in such a way on the basis of the rotor rotational speed and for the purpose of modifying the sound emission that the fan sound frequency deviates from the at least one generator sound frequency. In particular, the fan rotational speed of the at least one fan is set in accordance with an aspect found hereinabove. The explanations hereinabove regarding the method apply accordingly to the wind power installation.

### BRIEF DESCRIPTION OF THE SEVERAL VIEWS OF THE DRAWINGS

The invention is explained in more detail hereinbelow by way of example with reference to the accompanying figures.

FIG. 1 shows a wind power installation in a perspective view.

FIG. 2 shows, by way of example, a spectrum of a wind power installation at different rotational speeds.

FIG. 3 shows a rotational speed-dependent generator sound frequency.

FIG. 4 shows a diagram of a plurality of superposed sound signals.

### DETAILED DESCRIPTION

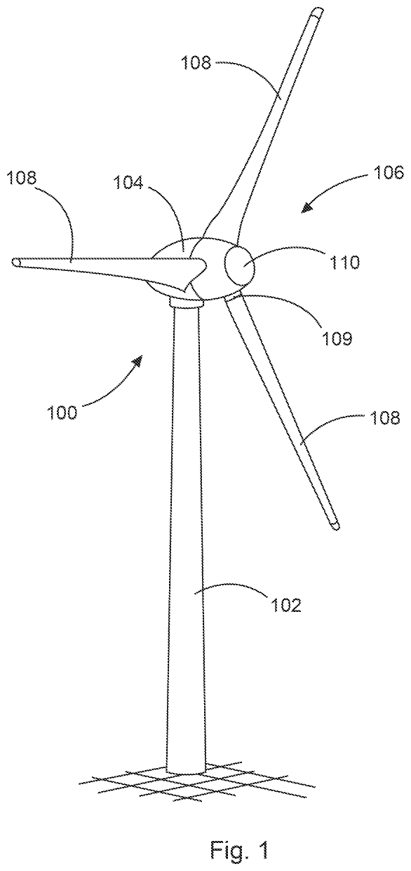

FIG. 1 shows a schematic illustration of a wind power installation according to an embodiment of the invention. The wind power installation 100 has a tower 102 and a nacelle 104 on the tower 102. An aerodynamic rotor 106 having three rotor blades 108 and a spinner 110 is provided on the nacelle 104. During the operation of the wind power installation, the aerodynamic rotor 106 is set in rotational motion by the wind and thereby also rotates an electrodynamic rotor or armature of a generator, which is coupled directly or indirectly to the aerodynamic rotor 106. The electric generator is arranged in the nacelle 104 and produces electrical energy. The blade angles of the rotor blades 108, which may also be referred to synonymously as the pitch angle or setting angle, can be modified by pitch motors at the rotor blade roots 109 of the respective rotor blades 108.

The wind power installation also has four heat-exchanger fans for cooling the generator.

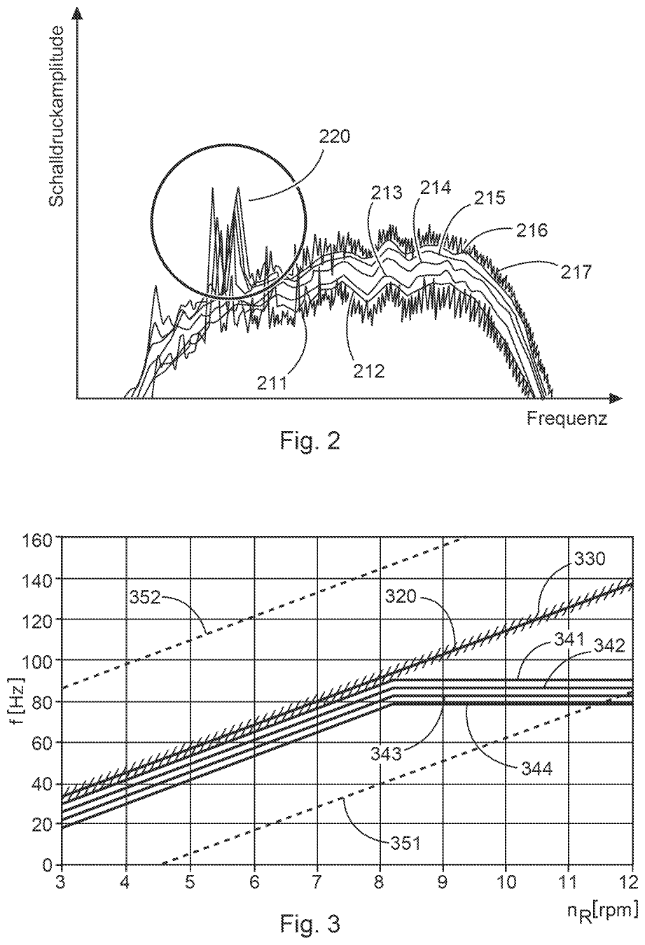

FIG. 2 shows a coordinate system in which respective sound pressure amplitudes of sound signals are depicted as a function of frequency. The coordinate system depicts seven actually recorded spectra 211, 212, 213, 214, 215, 216, 217 of the wind power installation at different rotor rotational speeds by way of example.

A peak which clearly rises from the surrounding base spectrum is identifiable in each of the spectra 211, 212, 213, 214, 215, 216, 217. The peak is a structure-related generator tone 220, which is located at the generator sound frequency and circled for clarity.

The more the generator tone 220 rises above the base spectrum, the more unpleasantly the sound is perceived. Consequently, the amplitudes of the peaks of the generator sound frequency should be prevented from being increased even further. To this end, the rotational speed of the fan is set so that a dominant tone in the sound of the fan has a fan sound frequency which differs from the generator sound frequency. Thus, a frequency range is avoided, the latter being determined on the basis of a frequency bandwidth of the peak, which is to say the generator tone 220 at the generator sound frequency.

The fan sound is not depicted in the coordinate system.

FIG. 3 shows a coordinate system where the frequency in Hz is plotted on the ordinate and the rotor rotational speed n_{R} in rpm is plotted on the abscissa. By way of example, a detail from 3 rpm to 12 rpm, and from 0 Hz to 160 Hz, is illustrated.

A characteristic generator sound frequency 320 is depicted. The generator sound frequency also increases with increasing rotor rotational speed. A frequency range 330 to be avoided around the generator sound frequency 320 is likewise depicted.

The fans of the wind power installation also produce a sound, which is superposed on the generator sound and which has a characteristic fan sound frequency in each case.

In this case, the fans are set in such a way in terms of their fan rotational speed that they avoid a critical fan rotational speed, specifically precisely the rotational speed that would lead to a fan sound with a fan sound frequency equal to the generator sound frequency. In the process, a rotational speed range to be avoided is also determined here, so that the fan sound frequency avoids the frequency range 330 to be avoided. Four fan sound frequencies 341, 342, 343, 344 are depicted. Consequently, each fan rotational speed is set so that the fan sound frequencies 341, 342, 343, 344 are not located in the frequency range 330 to be avoided.

It was also recognized that there can also be a disadvantageous superposition of the fan sound frequencies. The fan rotational speeds are therefore set in such a way that their fan sound frequencies 341, 342, 343, 344 differ from one another. In this case, a frequency spacing which must be observed by two fans is specified for the fans. This avoids a disadvantageous superposition.

A further aspect intended to be clarified by FIG. 3 lies in the masking of the generator tone. In this case, the peak of the generator tone in the spectrum should be broadened by virtue of the rotational speeds of the fans being set so that the fan sound frequencies 341, 342, 343, 344 are located in the vicinity of the generator sound frequency 320.

To this end, provision is also made for the rotational speeds of the fans to be set so that the fan sound frequencies are spaced apart by the frequency spacing. Consequently, the frequency spacing is chosen so that the generator tone is masked.

In this case, the frequency spacing is constant in FIG. 3. However, provision is also made, in particular, for the frequency spacing between the fans to be set differently. As a result, fan sound frequencies and generator sound frequency can be optimally matched to one another.

Consequently, the four fan sound frequencies 341, 342, 343, 344 are provided in the figure as fan sound frequency characteristics which are shifted relative to one another. Provision is also made for a respective fan rotational speed characteristic to be specified for the fan sound frequency characteristics, the said fan rotational speed characteristics being shifted with respect to one another and each achieving a maximum rotational speed. In this case, the maximum rotational speeds are also different and lead accordingly to a maximum frequency of the fan sound frequency characteristics.

FIG. 3 also shows a tone bandwidth of the generator sound as an ERB bandwidth, specifically a lower ERB limit 351 and an upper ERB limit 352.

To mask the generator tone at the generator sound frequency 320, provision is made for the rotational speeds of the fans to be specified so that the fan sound frequencies are located within the frequency range defined by the tone bandwidth, which is to say above the lower ERB limit 351 and below the upper ERB limit 352. This is only possible to a certain extent here since the fans have a maximum rotational speed. Thus, the fan is already operated at full power in that case. In the example, this is reached at a rotor rotational speed of approximately 8.2 rpm for the fan with the fan sound frequency 341. However, the frequency spacing between the fan sound frequencies should continue to be maintained.

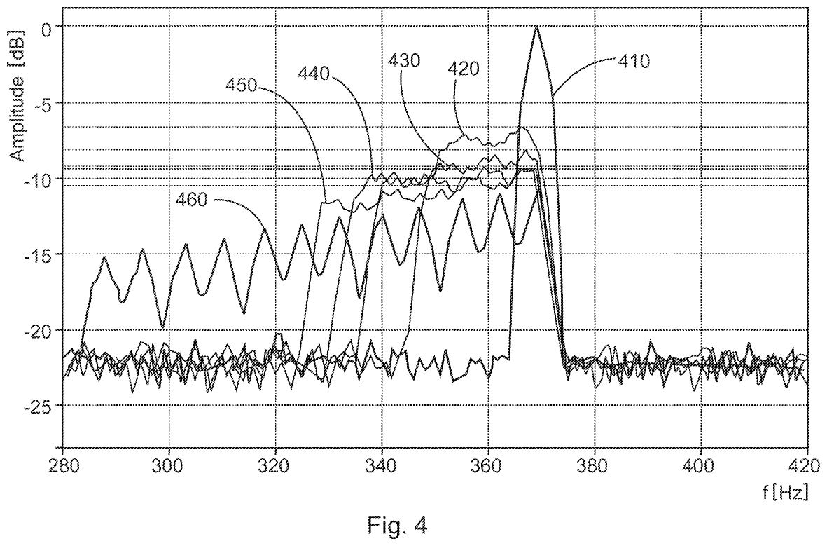

FIG. 4 shows a further coordinate system, in which an amplitude, specifically a sound pressure amplitude, of a plurality of sound spectra in dB is plotted against a frequency f in Hz. Shown is a simulation of a superposition of sound signals at twelve fan sound frequencies from twelve fans of identical construction, to form a resultant sound signal with the sound spectrum 410, 420, 430, 440, 450, 460. A different frequency spacing between the fans is chosen for each of the resultant sound spectra 410, 420, 430, 440, 450, 460, in order to thereby examine different superpositions. To this end, a corresponding (different) rotational speed is specified for each of the twelve fans. However, all fans have the same rotational speed in the case of the superposed sound spectrum 410. Rather than specifying a rotational speed, a respective power of the fan could be specified as an alternative. To simplify the explanation, the generator sound is not taken into account in this example.

The frequency spacing between all the fans is zero in the case of the superposed sound signal with the sound spectrum 410, which is to say the fans are all operated at the same rotational speed. Thus, all twelve fans are set to 100% of their nominal fan rotational speed. In the superposed sound signal with the sound spectrum 420, the rotational speed respectively differs by 0.5% from fan to fan. The frequency spacing is consequently constant. The frequency spacing is also constant in the case of the sound spectra 450 and 460. In this case, the fan rotational speeds vary by 1% and 2%, respectively, between each of the fans.

The sound spectra 430, 440 show the superposed sound of the twelve fans, in the case of which the frequency spacings between the various fans differ. Consequently, the rotational speed difference between the fans is not constant but varies from fan to fan.

The resultant sound spectrum 410 should be avoided since the sound signals of all 12 fans are disadvantageously superposed to form the sound with the sound spectrum 410 with the large peak. The peak has a narrow bandwidth and a large amplitude. Both of these are undesirable.

A sound signal with the sound spectrum 420 should also be avoided. A plurality of peaks can be identified in the spectrum in this case, the said peaks being perceivable as individual tones and possibly being perceived as annoying. A large frequency spacing between the fans, which is moreover constant between the fans, leads to a sound spectrum like the sound spectrum 460. Consequently, the fan rotational speed also decreases significantly from fan to fan in the case of such large frequency spacings. This is undesirable since this significantly reduces the mean cooling power of the totality of all fans.

A further advantage of the variable frequency spacing can also be found here. The amplitudes of sound spectra 430, 440 and 450 only differ slightly from one another. However, the frequency range of the sound spectrum 450 is significantly broader than in the case of the sound spectra 430, 440. The fan rotational speed of the slowest fan is consequently higher in the resultant sound with the spectra 430, 440 than in the resultant sound with the spectrum 450. Consequently, as a result of the variable frequency spacing, the mean cooling power of the fans is increased in the case of an otherwise approximately unchanged maximum amplitude.

Thus, a goal is to broaden the resultant spectrum over a frequency range to such an extent that a plateau with a low amplitude sets in. At the same time, the frequency range of the plateau should remain as small as possible in the process so that the mean cooling power of the fans is only reduced a little. This is especially the case for the resultant sound signals with sound spectra 430 and 440, in which the frequency spacing varies on an individual basis.

According to the invention, the following aspects and solutions in particular were recognized.

The invention relates in particular to the prevention of disadvantageous superposition of sound components from different sources of components of the wind power installation, or to an active masking of tonal components by means of one or more sound sources. The sound of the generator and one or more fans was recognized as being particularly relevant.

The invention also relates to an algorithm which is intended to prevent a disadvantageous acoustic superposition of a plurality of operationally dependent (rotational speed-dependent) sources of sound in a wind power installation. A further function is intended to be the targeted masking by “driving” or “controlling” a specific rotational speed range and/or frequency range of a source of sound, in order to obtain the best possible “masking” of a tone (usually from the generator).

The concept is described on the basis of an example of generator and heat-exchanger fan.

Generators emit a tone, which depends on the rotational speed, for structural reasons. It was recognized that this usually is the 12th harmonic.

In the case of a sound measurement pursuant to DIN 61400-11, there is an investigation within the tone analysis as to the extent to which the tone “emerges from” the remaining adjacent spectrum. The frequency range in which the analysis takes place depends on the frequency of the tone and is based on psychoacoustic discoveries.

In the case of high tone levels relative to the surrounding spectrum there may be a tone allowance (KTN>0), which may lead to a non-observance of the guarantees and hence to compensation costs. The nacelle of the wind power installation now contains further additional sources of sound, which are superposed on the sound from the generator.

A heat exchanger unit with four large fans is particularly critical from an acoustic point of view since it is situated directly on the back side of the nacelle and can emit in unimpeded fashion in the direction of the wake of the wind power installation, in which the sound is measured according to the standard.

Like the generator, the fans also have a dominant tone, which is referred to here as the characteristic fan sound frequency or blade passing frequency (BPF). Therefore, characteristic fan sound frequency, blade passing frequency and BPF can be used synonymously herein, or treated similarly. The fan sound frequency is also rotational speed dependent.

The algorithm should prevent the fan sound frequencies of the fans from being in the “avoidable region” at all times or at all rotational speeds, and from being superposed on the generator tone.

Depending on the application, it may also theoretically be possible for there to be a plurality of avoidable regions.

Further, all fans should be operated at differing fan rotational speeds where possible. However, the rotational speed difference between the fans should also be variable such that fan sound frequencies of fans may also be located “above” and “below” the generator tone in the spectrum. However, the fan sound frequencies will more frequently be located below the generator sound frequency for structural reasons.

The harmonics (multiples) of the fan sound frequency, and other possible installation-related dominant frequency ranges of the fan, must also be taken into account as appropriate according to their characteristics in the closed-loop control; this was recognized according to the invention.

Furthermore, the “fan index” should change at regular time intervals (e.g., every 15 minutes) so that there is more uniform cooling of cooling ribs or a coolant. As it were, the fans are thus exchanged among one another. Otherwise, the rotational speed shift would lead to differently strong flows through the cooler area, which would not be cooled uniformly as a result. This procedure could likewise be used for the generator fans in order to obtain more uniform cooling of the generator. This might have a positive effect on the efficiency.

Parameters selected from the following list, in particular, come into question as input parameters for the algorithm, the list comprising a number of fans, a number of blades or rotor blades of the fans, an order of the harmonics of the generator, a number of slots of the generator, a number of pole pairs of the generator, a tone bandwidth of the generator tone, a rotational speed of the generator, a minimal frequency spacing between the fans among themselves, a marker for masking (ON/OFF).

To the extent the marker for masking is ON, the fan tones, which is to say the characteristic fan frequencies, are driven into the vicinity of the generator sound frequency.

The target rotational speeds of the fans are determined as output parameters. The fan rotational speed of the fans is set in accordance with the target rotational speed.

The invention also serves for the acoustic optimization of a wind power installation. The invention is intended to prevent tonal zones from occurring or guaranteed sound power levels from being exceeded in certain one-third octave/octave bands. Such overshoots could lead to deactivations and hence loss of income. Furthermore, the masking should improve the “sonority” or reduce the “annoyance” of the wind power installation, in order to increase acceptance.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for modifying a sound emission of a wind power installation, wherein:
the wind power installation comprises a nacelle and a generator with a rotor which is adjustable in terms of its rotational speed, and the rotor has at least one rotor blade,
the generator produces sound with at least one characteristic generator sound frequency which depends on the rotor rotational speed,
the wind power installation has at least one fan for cooling at least one of the nacelle or generator,
a rotational speed of the at least one fan is adjustable, and
the at least one fan produces sounds having characteristic fan sound frequencies depending on the fan rotational speed, and the method comprising:
setting the fan rotational speed of the at least one fan depending on the rotor rotational speed such that the fan sound frequency deviates from the at least one generator sound frequency.

2. The method according to claim 1, wherein:
at least one critical fan rotational speed is determined based on the rotor rotational speed as a rotational speed to be avoided by the at least one fan,
the fan rotational speed of each fan is specified in such a way that the at least one critical fan rotational speed is avoided,
the at least one critical fan rotational speed is the same for fans of identical construction, and/or
the at least one critical fan rotational speed corresponds to a fan rotational speed at which the associated fan sound frequency corresponds to the generator sound frequency.

3. The method according to claim 1, wherein:
a harmonic of a frequency variable of the generator on which the sound depends is used as the generator sound frequency,
a fundamental frequency or harmonic of the sound produced by the at least one fan is used as the fan sound frequency, and
the fan sound frequency f_{L} is a blade passing frequency and the fan sound frequency f_{L} is determined based on the fan rotational speed n_{L} and a number of fan rotor blades A_{L}, and according to the formula:
$${f}_{L} [ Hz ] = {n}_{L} \frac{[ rpm ]}{60} \cdot {A}_{L} .$$

4. The method according to claim 1, wherein the fan rotational speed of the at least one fan is specified in such a way that an associated fan sound frequency deviates from the generator sound frequency by no more than a specifiable masking deviation to mask the generator sound frequency.

5. The method according to claim 1, wherein the critical fan rotational speed n_{L,i} is determined for each fan i based on:
the rotor rotational speed n_{R},
a number of pole pairs P_{G} of the generator,
a number or the number of fan rotor blades A_{L,i} of the fan i, and
an order k of the sound produced by the generator, with the order k as characteristic order of the generator, and/or as an order of a harmonic or the harmonic used as the generator sound frequency, wherein the critical fan rotational speed is determined as:
$${n}_{L , i} = \frac{{n}_{R} \cdot k \cdot {P}_{G}}{{A}_{L , i}} .$$

6. The method according to claim 1, wherein:
the wind power installation has a plurality of fans for cooling the nacelle and generator, wherein:
the plurality of fans have adjustable rotational speeds and produce sounds with a characteristic fan sound frequency depending on their respective fan rotational speed, and
each of the fan rotational speeds is set, respectively, dependent on the rotor rotational speed, in such a way that the respective fan sound frequency deviates from the generator sound frequency, and
the fan rotational speeds are set in such a way that their fan sound frequencies also differ from one another.

7. The method according to claim 1, wherein:
the at least one fan is a plurality of fans,
a frequency spacing is specified as a frequency difference respectively between two fan sound frequencies of two fans of the plurality of fans, and
the fan rotational speeds of the two fans are set such that fan sound frequencies of the two fans have frequency spacing from one another.

8. The method according to claim 1, wherein:
the at least one fan is a plurality of fans,
a frequency spacing is variably adjustable as the frequency difference respectively between two fan sound frequencies of two fans of the plurality of fans, and/or
the frequency spacing among the two fans is different from one another,
the frequency spacing is chosen based on at least one weather parameter from a list comprising:
an outside temperature,
a humidity,
an atmospheric pressure,
a rate of precipitation,
a droplet size,
a rate of snowfall, and
a wind speed.

9. The method according to claim 1, wherein:
the at least one fan is a plurality of fans, a frequency spacing is variably adjustable as the frequency difference respectively between two fan sound frequencies of two fans of the plurality of fans, and
the frequency spacing between the two fans reduces with increasing distance from the generator sound frequency.

10. The method according to claim 1, wherein:
the at least one fan is a plurality of fans,
a frequency spacing or the frequency spacing is specified as the frequency difference respectively between two fan sound frequencies of two fans of the plurality of fans depending on the rotor rotational speed, and
the frequency spacing is specified to be reduced as the rotor rotation speed is reduced.

11. The method according to claim 1, wherein:
the generator sound frequency has a tone bandwidth, an ERB bandwidth, as characteristic frequency bandwidth, with the tone bandwidth defining a characteristic frequency range around the generator sound frequency, and
a frequency range to be avoided, having an avoidance bandwidth, is determined based on the tone bandwidth, with the avoidance bandwidth defining a frequency range to be avoided as the frequency range around the generator sound frequency, and the avoidance bandwidth being smaller than the tone bandwidth, with a result that the frequency range to be avoided is located within the characteristic frequency range, and
the fan rotational speed of the at least one fan is set so that the fan sound frequency is located outside of the frequency range to be avoided and/or within the characteristic frequency range.

12. The method according to claim 1, wherein:
the fan rotational speed is specified as a fan rotational speed characteristic,
the fan rotational speed characteristic describes a function of the fan rotational speed depending on the rotor rotational speed, and
the fan rotational speed characteristic is provided as a linear characteristic.

13. The method according to claim 1, wherein:
the at least one fan is a plurality of fans,
a dedicated fan rotational speed characteristic is provided for each fan,
the fan rotational speed characteristics of the plurality of fans, respectively, deviate from one another by a specifiable rotational speed deviation criterion,
the fan rotational speed characteristics of a plurality of fans are shifted from one another by a specifiable difference rotational speed and/or deviate from one another by a rotational speed deviation factor ranging between 0.8 and 1.2, and/or
fan sound frequency characteristics, which are associated with the fan rotational speed characteristics and each describe a fan sound frequency depending on the rotor rotational speed, of a plurality of fans, respectively, deviate from one another by a specifiable frequency deviation criterion,
the fan sound frequency characteristics of a plurality of fans are shifted from one another by a specifiable difference frequency and/or deviate from one another by a frequency deviation factor which corresponds to the rotational speed deviation factor, ranging between 0.8 and 1.2.

14. The method according to claim 1, wherein the wind power installation has at least two fans for cooling the nacelle and/or generator, wherein:
the at least two fans are arranged in a fan sequence,
the fan rotational speeds or fan rotational speed characteristics of the at least two fans are selected in accordance with the fan sequence and
the fan sequence is modified in such a way after a specifiable exchange time or based on another exchange criterion that the fan rotational speeds or fan rotational speed characteristics of the fans are selected anew in accordance with the modified fan sequence.

15. The method according to claim 1, wherein the wind power installation generates at least one further noise, and
wherein the at least one further noise is a sound with constant frequency, and
wherein the fan rotational speed of the at least one fan is set such that the fan sound frequency deviates from the constant frequency.

16. The method according to claim 1, wherein a harmonic of a pole passing frequency of the generator on which the sound depends is used as the generator sound frequency, wherein the harmonic of the pole passing frequency specifies how often a rotor pole passes a reference position.

17. A wind power installation comprising:
a nacelle,
a generator with a rotor, wherein a rotational speed of the rotor is adjustable, wherein the rotor has at least one rotor blade, and
a control module,
wherein the generator produces sound with at least one characteristic generator sound frequency depending on a rotor rotational speed,
wherein the wind power installation has at least one fan for cooling the nacelle and/or generator,
wherein a fan rotational speed of the at least one fan is adjustable,
wherein the at least one fan produces sound with a characteristic fan sound frequency which depends on the fan rotational speed, and
wherein the control module is configured to set a fan rotational speed of the at least one fan in such a way based on the rotor rotational speed and for the purpose of modifying a sound emission that the fan sound frequency deviates from the at least one generator sound frequency.
